(19) United States
(12) Patent Application Publication
(10) Pub. No.: US 2016/0164097 A1
(43) Pub. Date: Jun. 9, 2016

(54) Anode Mixture for Lithium Secondary Battery, Anode for Lithium Secondary Battery and Lithium Secondary Battery Using the Same

(71) Applicant: SK Innovation Co., Ltd., Seoul (KR)

(72) Inventor: Jae-Yun Min, Daejeon (KR)

(21) Appl. No.: 14/963,478

(22) Filed: Dec. 9, 2015

(30) Foreign Application Priority Data
Dec. 9, 2014 (KR) 10-2014-0176072

(51) Int. Cl. H01M 4/62; H01M 4/587; H01M 10/0525; H01M 4/133

(52) U.S. Cl. CPC H01M 4/62; H01M 4/133; H01M 4/587; H01M 4/622; H01M 10/0525; H01M 2004/027

(57) ABSTRACT

Disclosed are an anode mixture including an anode active material, a binder and a metal oxide filler having a particle diameter of 200 nm to 200 μm, which can provide a high-density anode with improved electrolyte impregnation property in an electrode, excellent cycle property and high-temperature storage property, and high capacity density per volume, as well as an anode for a lithium secondary battery, and a lithium secondary battery using the same.

### CROSS-REFERENCE TO RELATED APPLICATION

This application claims priority to Korean Patent Application No. 10-2014-0176072 filed Dec. 9, 2014, the disclosure of which is hereby incorporated in its entirety by reference.

### BACKGROUND OF THE INVENTION

1. Field of the Invention

The present invention relates an anode mixture for a lithium secondary battery, an anode for a lithium secondary battery, and a lithium secondary battery using the same.

2. Description of the Related Art

With rapid progress of electric, electronic, telecommunication and computer industries, a demand for a secondary battery with high performance and high stability has been gradually increased. In particular, with a tendency toward decrease in weight, thickness and size of precision electric/electronic products and portable application thereof, a secondary battery as a key part in this field, is also required for decreasing a thickness and size thereof.

In response of such requirements, one of devices which have recently come into most spotlight is a lithium secondary battery.

An electrode density of an anode often used for a lithium secondary battery ranges from 1.4 to 1.6 g/cc. Therefore, in order to increase the electrode density of the anode, when a press process is executed, electrolyte impregnation property is considerably reduced, hence causing a problem in the process of manufacturing batteries. Further, there is another problem such that life-span property of the battery is also deteriorated.

Accordingly, in order to solve the above-described problems, there have been attempts to mix high-strength fine graphite or add a carbon black-based conductive material to the anode. However, in this case, the electrolyte is decomposed to decrease initial efficiency of an electrode, and causes a problem of deteriorating a side reaction of the electrolyte at a high temperature.

Korean Patent Laid-Open Publication No. 2001-0064617 discloses a technique of inhibiting generation of dendrite occurred during charging/discharging a battery, which includes adding a polymer electrolyte to lithium metal micro-granular powders. However, the above publication has not proposed an alternative solution in regard to the above-described problems.

### SUMMARY OF THE INVENTION

Accordingly, it is an object of the present invention to provide an anode mixture for a lithium secondary battery capable of forming a high-density anode.

Another object of the present invention is to provide an anode mixture for a lithium secondary battery with improved electrolyte impregnation property in an electrode during manufacturing a high-density anode.

Further, another object of the present invention is to provide an anode for a lithium secondary battery, which has a high density, remarkably improved cycle property and high-temperature storage property, and a high capacity density per volume.

The above objects of the present invention will be achieved by the following characteristics:

(1) An anode mixture for a lithium secondary battery, comprising an anode active material, a binder and a metal oxide filler having a particle diameter of 200 nm to 200 μm.

(2) The anode mixture for a lithium secondary battery according to the above (1), wherein the filler is at least one selected from a group consisting of aluminum oxide (Al₂O₃), aluminum hydroxide (Al(OH)₃), barium titanate (BaTiO₃), zinc oxide (ZnO), barium oxide (BaO), zirconium oxide (ZrO₂), titanium oxide (TiO₂), lithium titanium oxide, and lithium cobalt oxide.

(3) The anode mixture for a lithium secondary battery according to the above (1), wherein the filler has a particle diameter ranging from 250 nm to 1.5 μm.

(4) The anode mixture for a lithium secondary battery according to the above (1), wherein the filler includes ferroelectrics.

(5) The anode mixture for a lithium secondary battery according to the above (4), wherein the ferroelectrics includes at least one selected from a group consisting of lead titanate (PbTiO₃), lead titanate zirconate (PbTiO₃—PbZrO₃) and ammonium dihydrogen phosphate (NH₄H₂PO₄).

(6) The anode mixture for a lithium secondary battery according to the above (1), wherein the filler is included in an amount of 0.5 to 10% by weight to a total weight of the anode mixture.

(7) The anode mixture for a lithium secondary battery according to the above (1), wherein the anode active material includes at least one carbon material selected from a group consisting of artificial graphite in a potato form, artificial graphite in a mesocarbon microbead (MCMB) form, surface-treated natural graphite, hard carbon obtained by thermal decomposition of a phenolic resin, hard carbon obtained by thermal decomposition of a furan resin, cokes, needle cokes and soft carbon obtained by carbonization of pitch.

(8) The anode mixture for a lithium secondary battery according to the above (1), wherein the binder is at least one selected from a group consisting of polytetrafluoroethylene (PTFE), polyvinylidenefluoride (PVdF), cellulose, polyvinyl alcohol, carboxymethyl cellulose (CMC), starch, hydroxypropyl cellulose, polyvinyl pyrrolidone, tetrafluoroethylene, polyethylene, polypropylene, ethylene-propylene-diene copolymer (EPDM), sulfonated ethylene-propylene-diene copolymer (EPDM), styrene-butadiene rubber and fluorine rubber.

(9) An anode for a lithium secondary battery, fabricated using the anode mixture for a lithium secondary battery according to the above (1).

(10) The anode for a lithium secondary battery according to the above (9), wherein the anode has an electrode density of 1.6 g/cc or more.

(11) A lithium secondary battery comprising the anode for a lithium secondary battery according to the above (9).

When using the anode mixture for a lithium secondary battery of the present invention, it is possible to prepare a high-density anode for a lithium secondary battery having improved electrolyte impregnation property in an electrode. Further, when using the anode mixture for a lithium secondary battery of the present invention, it is possible to prepare an anode for a lithium secondary battery having remarkably improved cycle property and high-temperature storage property, and a high capacity density per volume.

### DETAILED DESCRIPTION OF THE INVENTION

The present invention discloses an anode mixture including an anode active material, a binder and a metal oxide filler having a particle diameter of 200 nm to 200 μm, which can provide a high-density anode with improved electrolyte impregnation property in an electrode, excellent cycle property and high-temperature storage property, and high capacity density per volume, as well as an anode for a lithium secondary battery, and a lithium secondary battery using the same.

Anode Mixture for a Lithium Secondary Battery

The anode mixture for a lithium secondary battery of the present invention includes an anode active material, a binder and a metal oxide filler having a particle diameter of 200 nm to 200 μm.

According to the present invention, the filler may include aluminum oxide (Al₂O₃) having a particle diameter of 200 nm to 200 μm.

With regard to the lithium secondary battery, when a press process is executed to form an electrode having a high density, electrolyte impregnation property and charge/discharge capacity are reduced. In order to solve this problem, when adding high-strength fine graphite or carbon black-based conductive material, there are problems that the electrolyte is decomposed at an edge of the electrode to reduce initial efficiency of the electrode, while accelerating a side reaction of the electrolyte at a high temperature.

In this regard, the anode mixture of the present invention includes a metal oxide filler having a high strength and excellent affinity to an electrolyte, thereby securing a minimum path of the electrolyte while not blocking the path even when executing the press process during manufacturing a high density anode. Accordingly, a high density anode for a lithium secondary battery with improved electrolyte impregnation property may be provided.

Further, using the anode mixture of the present invention may provide an anode for a lithium secondary battery, which exhibits excellent cycle property during manufacturing the high density anode, prevents the side reaction of the electrolyte at a high temperature to remarkably increase high-temperature storage property, and has a high capacity density per volume.

The metal oxide filler has a particle diameter ranging from 200 nm to 200 μm. If the particle diameter of the filler is less than 200 nm, it is difficult to secure an electrolyte impregnation path. If the particle diameter exceeds 200 μm, the electrode becomes thick too much, and thereby the electrode cannot be rolled. The particle diameter of the meal oxide filler preferably ranges from 250 nm to 1.5 μm. Within the above range, it is easier to secure the electrolyte impregnation path, and thereby maximizing electrolyte impregnation property. Further, cycle property and high-temperature storage improvement may be significantly increased.

According to the present invention, types of the metal oxide filler are not particularly limited so long as those are generally used in the related art and do not depart from the purposes of the present invention. Preferably, aluminum oxide (Al₂O₃), aluminum hydroxide (Al(OH)₃), barium titanate (BaTiO₃), zinc oxide (ZnO), barium oxide (BaO), zirconium oxide (ZrO₂), titanium oxide (TiO₂), lithium titanium oxide, lithium cobalt oxide, or the like, may be exemplified. In this case, when the metal oxide filler has a particle diameter within a specific range, a function thereof may be further reinforced. The above compounds may be used alone or in combination of two or more thereof.

As necessary, the filler of the present invention may further include ferroelectrics. In this case, due to strong and permanent polarity of the ferroelectrics, improvement of adhesion through electrostatic interaction between the binder and the ferroelectrics may be significantly increased.

The ferroelectrics according to the present invention may include barium titanate (BaTiO₃), lead titanate (PbTiO₃), lead titanate zirconate (PbTiO₃—PbZrO₃), ammonium dihydrogen phosphate (NH₄H₂PO₄), or the like. These may be used alone or in combination of two or more thereof.

The ferroelectrics may have a particle diameter ranging from 200 nm to 200 μm.

The filler according to the present invention may be included in an amount of 0.5 to 10% by weight (‘wt. %’) to a total weight of the anode mixture for a lithium secondary battery. Within the above range, characteristics of the battery such as electrolyte impregnation property, cycle property, high-temperature storage property, etc. may be more improved.

The anode mixture of the present invention may further include an anode active material other than the above filler.

The anode active material enables absorption and desorption of lithium ions, and some materials known as a component of the anode active material in the related art may be included without particular limitation thereof, and a carbon material is preferably used. More particularly, artificial graphite in a potato form, artificial graphite in a mesocarbon microbead (MCMB) form, surface-treated natural graphite, hard carbon obtained by thermal decomposition of a phenolic resin, hard carbon obtained by thermal decomposition of a furan resin, cokes, needle cokes and soft carbon obtained by carbonization of pitch, or the like may be exemplified. These may be used alone or in combination of two or more thereof. The carbon material may have a particle diameter of 5 to 25 μm.

Further, the anode mixture of the present invention may include a binder.

The binder may include any one generally used in the related art without particular limitation thereof so long as it meets the purposes of the present invention. More particularly, polytetrafluoroethylene (PTFE), polyvinylidene fluoride (PVdF), cellulose, polyvinylalcohol, carboxymethyl cellulose (CMC), starch, hydroxypropyl cellulose, polyvinylpyrrolidone, tetrafloroethylene, polyethylene, polypropylene, ethylene-propylene-diene copolymer (EPDM), sulfonated ethylene-propylene-diene copolymer (EPDM), styrene-butadiene rubber, fluorine rubber, or the like, may be exemplified. These may be used alone or in combination of two or more thereof.

Other than the above components, the anode mixture of the present invention may further include any material known in the related art as a component of such an anode mixture as described above, without particular limitation thereof. In particular, for example, a conductive material, a solvent, etc. may be further included.

Types of the conductive material are not particularly limited so long as those are generally used in the related art and meets the purposes of the present invention. More particularly, a carbon material such as carbon black, acetylene black, thermal black, channel black, furnace black, graphite, etc.; a conductive material such as metallic fiber; metal powders such as carbon fluoride, aluminum, nickel powders, etc.; a conductive whisker such as zinc oxide, potassium titanate, etc.; a conductive metal oxide such as titanium oxide; a conductive substance such as polyphenylene derivatives, etc., may be exemplified.

The solvent is not particularly limited so long as it is any one generally used in the related art and meets the purposes of the present invention. More particularly, dimethyl sulfoxide (DMSO), alcohol, N-methyl pyrrolidone (NMP), acetone, or the like, may be exemplified. These may be used alone or in combination of two or more thereof.

Anode for a Lithium Secondary Battery and Lithium Secondary Battery

The anode for a lithium secondary battery according to one embodiment of the present invention may be prepared using the above-described anode mixture for a lithium secondary battery. More particularly, the anode for a lithium secondary battery may be formed by applying the anode mixture for a lithium secondary battery to an anode collector.

The anode collector may be prepared in a thickness of 3 to 500 μm. Such an anode collector is not particularly limited so long as it has conductive property while not inducing chemical modification in the battery. For example, copper, stainless steel, aluminum, nickel, titanium, sintered carbon, copper or stainless steel having a surface treated with carbon, nickel, titanium, silver, etc., an aluminum-cadmium alloy, or the like, may be used.

A method of uniformly coating the anode collector with the anode mixture may be selected from conventional methods known in the related art, otherwise, include any suitable new technique, in view of characteristics of materials. For instance, after spreading the anode mixture on the collector, it may be uniformly dispersed throughout the collector using a doctor blade or the like. Occasionally, spreading and dispersing may be executed in a single process. Besides, die-casting, comma coating, screen printing, etc. may also be employed. Alternatively, after molding on another substrate, the molded product may be combined with a collector through a method such as pressing or lamination.

The anode mixture applied to the collector may be dried in a vacuum oven at 50° C. to 200° C. for 12 to 72 hours.

The anode for a lithium secondary battery of the present invention may have an electrode density of 1.6 g/cc or more. An upper limit of the electrode density is not particularly limited when the upper limit is within a range meeting the purposes of the present invention. For instance, the upper limit thereof may be 2.0 g/cc. Even if the anode for a lithium secondary battery of the present invention has a high density, electrolyte impregnation property is not reduced, while cycle property and high-temperature storage property are significantly improved and a high capacity density per volume is achieved.

Further, the lithium secondary battery according to one embodiment of the present invention may have an electrode assembly wound through a separator installed between a cathode and an anode, as well as a case which houses the electrode assembly. The cathode, anode and separator may be impregnated in the electrolyte.

The cathode may be, for example, formed by applying a mixture of a cathode active material, a conductive material and a binder to a cathode collector, and drying the same. In addition, the application method may include those described above, within the same category.

The separator, which is present between the cathode and the anode, may be prepared using a thin insulation film having high ion transmittance and mechanical strength. Such a separator is not particularly limited so long as it is any one generally used in the related art and within a range meeting the purposes of the present invention. More particularly, a sheet or non-woven fabric made of olefin polymer such as polypropylene having chemical resistance and hydrophobic property, glass fiber or polyethylene, etc., may be used. When using a solid electrolyte such as polymer, the electrolyte may also function as the separator.

The electrolyte may contain a lithium salt, and in order to enhance cycle property and high temperature retaining ability, may further include pyridine, triethanolamine, carbon dioxide gas, or the like.

Hereinafter, the present invention will be described in detail with reference to the following examples.

### Example 1

### Cathode

Li_{1.0}Ni_{0.6}Co_{0.2}Mn_{0.2}O₂ as a cathode active material, Denka Black as a conductive material, polyvinylidene fluoride (PVDF) as a binder, and N-Methyl pyrrolidone as a solvent were used to prepare a cathode mixture having a weight ratio of 46:2.5:1.5:50, respectively. Next, the prepared mixture was applied to an aluminum substrate to coat the same, followed by drying and pressing to prepare a cathode.

<Anode>

47.5 wt. parts of natural graphite as an anode active material, wt. part/1 wt. part of a styrene-butadiene rubber (SBR)/carboxymethyl cellulose (CMC)-based binder, 0.5 wt. parts of aluminum oxide (Al₂O₃) having a particle diameter of 360 nm, and 50 wt. parts of pure water were mixed together to prepare an anode mixture.

The prepared anode mixture was applied to a copper substrate, followed by drying and pressing, thereby preparing an anode having an electrode density of 1.8 g/cc.

<Battery>

By notching a cathode plate and an anode plate in a suitable size, respectively, laminating the same, and installing a separator (polyethylene with a thickness of 25 μm) between the cathode plate and the anode plate, a battery was fabricated. Then, tap parts of the cathode and anode were welded, respectively.

A combination of the welded cathode/separator/anode was placed in a pouch, followed by sealing three sides of the assembly except for one side into which an electrolyte is injected. In this case, a portion having the gap is included in the sealing portion. After injecting the electrolyte through the remaining one side, the one side was also sealed, followed by impregnation for 12 hours or more. The electrolyte used herein was formed by preparing a 1M LiPF₆ solution with a mixed solvent of ethylene carbonate (EC)/ethylmethyl carbonate (EMC)/diethylene carbonate (DEC) in a volume ratio of 25/45/30, and adding 1 wt. % vinylene carbonate (VC), 0.5 wt % 1,3-propenesulton (PRS) and 0.5 wt. % lithium bis(oxalato)borate (LiBOB) to the above solution.

After then, pre-charging was conducted with a current (2.5 A) corresponding to 0.25 C for 36 minutes. After 1 hour, degassing and then ageing were conducted for 24 hours or more, followed by chemical charging/discharging (charge condition: CC-CV 0.2 C 4.2 V 0.05 C CUT-OFF, discharge condition: CC 0.2 C 2.5 V CUT-OFF).

Thereafter, standard charging/discharging was conducted (charge condition: CC-CV 0.5 C 4.2 V 0.05 C CUT-OFF, discharge condition: CC 0.5 C 2.5 V CUT-OFF)

### Example 2

The same procedures as described in Example 1 were conducted to fabricate a lithium secondary battery except that 1 wt. part of zinc oxide (ZnO) was further added as a filler to the anode.

### Example 3

The same procedures as described in Example 1 were conducted to fabricate a lithium secondary battery except that 1 wt. part of barium titanate (BaTiO₃) was further added as a filler to the anode.

### Example 4

The same procedures as described in Example 1 were conducted to fabricate a lithium secondary battery except that 0.5 wt. parts of zinc oxide (ZnO) and 0.5 wt. parts of barium titanate (BaTiO₃) were further added as a filler to the anode.

### Comparative Example 1

The same procedures as described in Example 1 were conducted to fabricate a lithium secondary battery except that the metal oxide filler was not included.

### Comparative Example 2

The same procedures as described in Example 1 were conducted to fabricate a lithium secondary battery except that the metal oxide filler was not included, but 1 wt. part of carbon black was included as a conductive material.

### Comparative Example 3

The same procedures as described in Example 1 were conducted to fabricate a lithium secondary battery except that the metal oxide filler has a particle diameter of 150 nm.

### Comparative Example 4

The same procedures as described in Example 1 were conducted to fabricate a lithium secondary battery except that the metal oxide filler has a particle diameter of 300 μm.

### Comparative Example 5

The same procedures as described in Example 1 were conducted to fabricate a lithium secondary battery except that natural graphite coated with aluminum oxide (Al₂O₃) was used as an active material, but the metal oxide filler was not mixed.

### Experimental Example 1

### Evaluation of Electrolyte Impregnation Property

The prepared anode mixture was placed on an electronic balance, and 20 ml of electrolyte was added to the sample. After visibly observing the anode mixture until the electrolyte was completely soaked into the anode mixture, a time for complete impregnation was measured. The results thereof are listed in Table 1 below.

As the time for complete impregnation is longer, the anode has lower impregnation property.

### Experimental Example 2

### Evaluation of Cycle Property

After repeatedly charging (CC-CV 2.0 C 4.2 V 0.05 C CUT-OFF) and discharging (CC 2.0 C 2.75 V CUT-OFF) the battery fabricated in each of the examples and comparative examples, 500 times, a discharge amount at 500 time was calculated by % relative to a discharge amount at 1 time, so as to determine cycle property at room temperature. The results thereof are listed in Table 1 below.

### Experimental Example 3

### Evaluation of High Temperature Storage Property—Capacity Recovery Rate

After storing the battery charged under a condition of CC-CV 0.5 C 4.2 V 0.05 C CUT-OFF according to each of the examples and comparative examples in an oven at 60° C. for 4 weeks, the battery was discharged under a condition of CC 0.5 C 2.75 V CUT-OFF, then, charged again under a condition of CC-CV 0.5 C 4.2 V 0.05 C CUT-OFF, and discharged again under a condition of CC 0.5 C 2.75 V CUT-OFF. This discharge amount was compared to a discharge amount at standard charging/discharging, to measure a capacity recovery rate. The results thereof are listed in Table 1 below.

### Experimental Example 4

### Evaluation of Capacity Density Per Volume

By dividing the energy value (Wh) measured at standard charging/discharging in the examples and comparative examples with a volume of cell (unit: L, width of cell×width×charge thickness), a capacity density per volume was calculated. The results thereof are listed in Table 1 below.

TABLE 1

| | | | | | Comparative | Comparative | Comparative | Comparative | Comparative |
|---|---|---|---|---|---|---|---|---|---|
| | Example | Example | Example | Example | Example | Example | Example | Example | Example |
| Section | 1 | 2 | 3 | 4 | 1 | 2 | 3 | 4 | 5 |
| Electrode | 1.8 | 1.8 | 1.8 | 1.8 | 1.8 | 1.8 | 1.8 | 1.8 | 1.8 |
| density | | | | | | | | | |
| (g/cc) | | | | | | | | | |
| Electrolyte | 386 | 358 | 264 | 312 | 657 | 423 | 599 | 634 | 532 |
| impregnation | | | | | | | | | |
| (sec) | | | | | | | | | |
| Cycle | 86 | 85 | 92 | 88 | 76 | 79 | 75 | 77 | 79 |
| property | | | | | | | | | |
| (%) | | | | | | | | | |
| High | 93 | 93 | 95 | 94 | 88 | 80 | 90 | 89 | 92 |
| temperature | | | | | | | | | |
| storage | | | | | | | | | |
| (%) | | | | | | | | | |
| property | | | | | | | | | |
| Capacity | 470 | 465 | 465 | 465 | 435 | 420 | 433 | 427 | 431 |
| density | | | | | | | | | |
| per | | | | | | | | | |
| volume | | | | | | | | | |
| (Wh/L) | | | | | | | | | |

Referring to Table 1, it can be seen that the examples included within the range of the present invention exhibit excellent electrolyte impregnation property and can implement a high-density electrode, compared to the comparative examples. In addition, it could be confirmed that the examples have improved cycle property, high-temperature storage property and capacity density per volume, compared to the comparative examples.

What is claimed is:

1. An anode mixture for a lithium secondary battery, comprising an anode active material, a binder and a metal oxide filler having a particle diameter of 200 nm to 200 μm.

2. The anode mixture for a lithium secondary battery according to claim 1, wherein the filler is at least one selected from a group consisting of aluminum oxide (Al₂O₃), aluminum hydroxide (Al(OH)₃), barium titanate (BaTiO₃), zinc oxide (ZnO), barium oxide (BaO), zirconium oxide (ZrO₂), titanium oxide (TiO₂), lithium titanium oxide, and lithium cobalt oxide.

3. The anode mixture for a lithium secondary battery according to claim 1, wherein the filler has a particle diameter ranging from 250 nm to 1.5 μm.

4. The anode mixture for a lithium secondary battery according to claim 1, wherein the filler includes ferroelectrics.

5. The anode mixture for a lithium secondary battery according to claim 4, wherein the ferroelectrics includes at least one selected from a group consisting of lead titanate (PbTiO₃), lead titanate zirconate (PbTiO₃—PbZrO₃) and ammonium dihydrogen phosphate (NH₄H₂PO₄).

6. The anode mixture for a lithium secondary battery according to claim 1, wherein the filler is included in an amount of 0.5 to 10% by weight to a total weight of the anode mixture.

7. The anode mixture for a lithium secondary battery according to claim 1, wherein the anode active material includes at least one carbon material selected from a group consisting of artificial graphite in a potato form, artificial graphite in a mesocarbon microbead (MCMB) form, surface-treated natural graphite, hard carbon obtained by thermal decomposition of a phenolic resin, hard carbon obtained by thermal decomposition of a furan resin, cokes, needle cokes and soft carbon obtained by carbonization of pitch.

8. The anode mixture for a lithium secondary battery according to claim 1, wherein the binder is at least one selected from a group consisting of polytetrafluoroethylene (PTFE), polyvinylidenefluoride (PVdF), cellulose, polyvinyl alcohol, carboxymethyl cellulose (CMC), starch, hydroxypropyl cellulose, polyvinyl pyrrolidone, tetrafluoroethylene, polyethylene, polypropylene, ethylene-propylene-diene copolymer (EPDM), sulfonated ethylene-propylene-diene copolymer (EPDM), styrene-butadiene rubber and fluorine rubber.

9. An anode for a lithium secondary battery, fabricated using the anode mixture for a lithium secondary battery according to claim 1.

10. The anode for a lithium secondary battery according to claim 9, wherein the anode has an electrode density of 1.6 g/cc or more.

11. A lithium secondary battery comprising the anode for a lithium secondary battery according to claim 9.
